(19) United States
(12) Patent Application Publication
(10) Pub. No.: US 2010/0262527 A1
(43) Pub. Date: Oct. 14, 2010

(54) COMMODITY BROKERING SYSTEM FOR MATCHING BUYERS AND SELLERS AND ASSOCIATED METHODS

(75) Inventor: John W. Mandigo, Orlando, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: STRATEGIC MARKET LLC, Orlando, FL (US)

(21) Appl. No.: 12/680,611

(22) PCT Filed: Jan. 22, 2009
(86) PCT No.: PCT/US09/31738

§ 371 Date: Mar. 29, 2010

Related U.S. Application Data
(60) Provisional application No. 61/022,546, filed on Jan. 22, 2008.

(51) Int. Cl. G06Q 40/00

(52) U.S. Cl. 705/37

(57) ABSTRACT

A method for establishing a connection between a buyer and a seller of a commodity gathering buyer demographic data and purchase criteria and querying a database containing sellers' data. The query method includes using the buyer's criteria set as a filter, and creating a data set including at least one potential seller having a commodity matching at least some of the buyer's criteria set. The software then transmits to at least one of the sellers in the data set at least some of the buyer's demographic data and criteria set, affording that set of sellers the opportunity to contact the buyer directly and make an offer of the seller's commodity. In some cases, negotiations can be entered into in order to reach an optimal result for the buyer and the seller. If successful, a purchase can be completed between the buyer and at least one of the sellers.

### CROSS-REFERENCE TO RELATED APPLICATIONS

This application claims the benefit of U.S. Provisional Application Ser. No. 61/022,546, filed on Jan. 22, 2008, the contents of which are hereby incorporated by reference in their entirety.

### FIELD OF THE INVENTION

The present invention relates to systems and methods for establishing contact between a buyer and a seller of an item, and, more particularly, to such systems and methods for establishing contact between a buyer and a seller of a relatively large-ticket item, such as, but not intended to be limited to, real estate.

### BACKGROUND OF THE INVENTION

A traditional method of searching for real estate is to hire a realtor, have him/her check a database, such as multiple listings, and select from among available properties based upon a set of criteria representing one's desires and financial position. A realtor may also offer the buyer the opportunity to examine a new property being offered by a builder. Another method is for the buyer to search him/herself, whether in traditional print media or online, using the same set of criteria as a filter. In each of these methods, the buyer is seeking a seller prior to a negotiation ensuing, and the seller has no access to buyers prior to being contacted by one, and must rely on multiple listings and other forms of advertisement to reach buyers.

This model is true for other commodities such as automobiles and other high-cost items.

It would be advantageous to provide a method and model for establishing a connection between a buyer and a seller wherein the seller can initiate at least some of the communication.

### SUMMARY OF THE INVENTION

The present invention is directed to a method for establishing a connection between a buyer and a seller of a commodity, for brokering a sale of the commodity. Typically this model will be effective for high-cost items, such as real estate and automobiles, although this is not intended as a limitation.

The method comprises a buyer providing demographic data and a set of purchase criteria, for example, on a website constructed for at least that purpose. The purchase criteria can include, but are not intended to be limited to, price range, search location, and physical characteristics of the commodity.

Software in communication with the website receives the buyer's criteria set and queries a database containing data previously entered by a plurality of sellers of the commodity, for which the sellers will have purchased a subscription. The query method includes using the buyer's criteria set as a filter, and creating a data set comprising at least one potential seller having a commodity matching at least some of the buyer's criteria set.

The software then transmits to at least one of the sellers in the data set at least some of the buyer's demographic data and criteria set, affording that set of sellers the opportunity to contact the buyer directly and make an offer of the seller's commodity. In some cases, negotiations can be entered into, perhaps with multiple sellers and/or multiple buyers, in order to reach an optimal result for the buyer and the seller. If successful, a purchase can be completed between the buyer and at least one of the sellers.

In this model, it is possible for buyers and sellers to eliminate commissions to intermediary agents such as realtors and automobile salespeople, and thereby permit an agreement to be reached wherein the seller can offer the commodity at a lower price, potentially saving both the buyer and the seller money. Further, the buyer can more easily establish a “bidding” situation between multiple sellers to achieve the best result, and can perhaps receive additional features for the commodity without additional cost as part of a negotiation.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is an exemplary schematic diagram for the commodity brokering system.

FIGS. 2A-2C is a flowchart of an exemplary embodiment of the commodity brokering method of the present invention.

FIGS. 3-5 are exemplary web pages associated with the commodity brokering system.

### DETAILED DESCRIPTION OF PREFERRED EMBODIMENTS

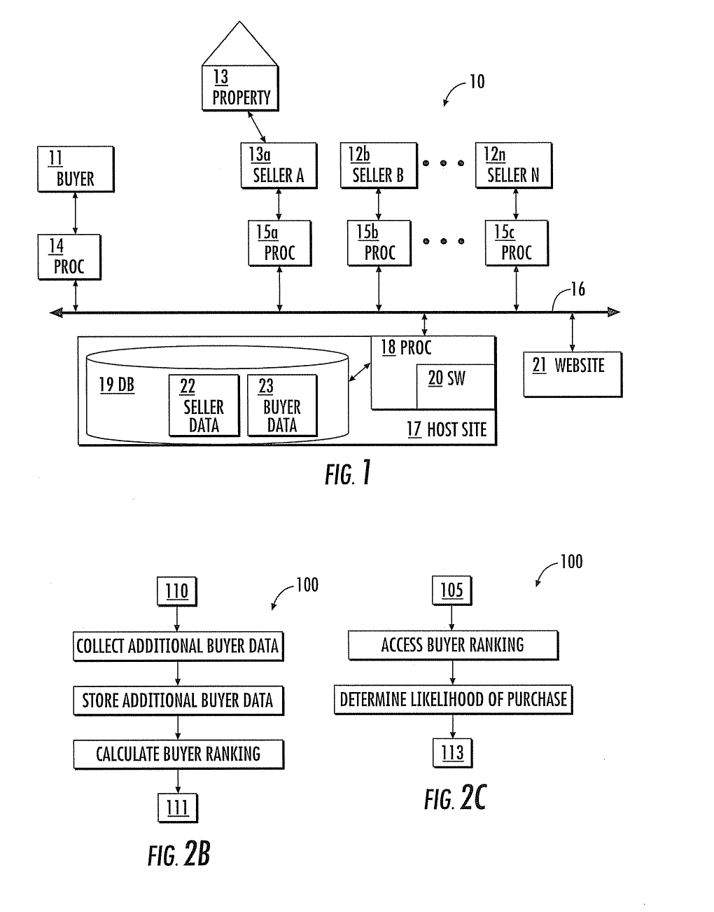

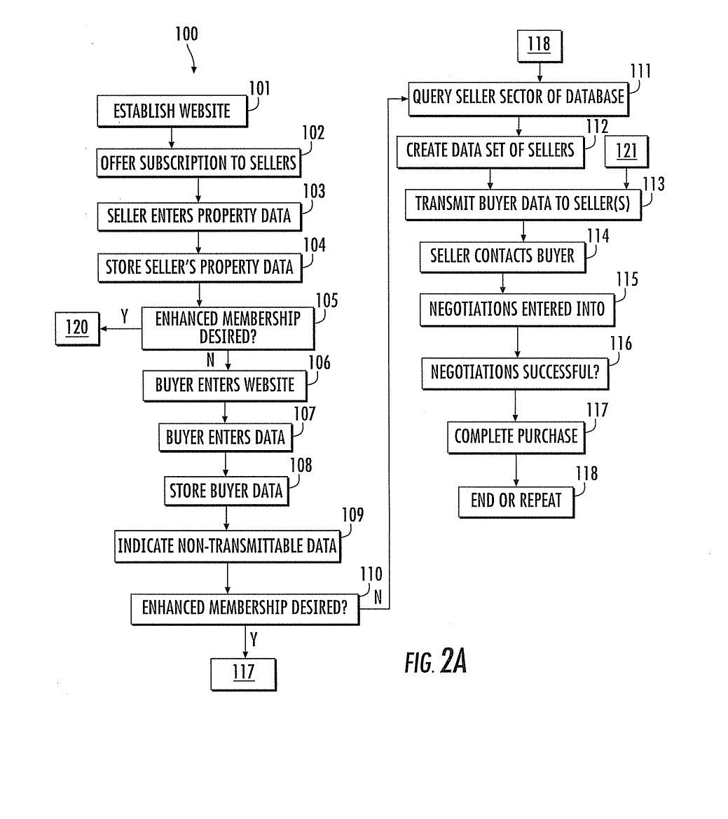

A description of the preferred embodiments of the present invention will now be presented with reference to FIGS. 1-2C. This embodiment is directed to the sale of real estate, but it will be understood by one of skill in the art that any commodity could be encompassed, and that this embodiment is not intended as a limitation.

The system 10 (FIG. 1) and method 100 (FIGS. 2A-2C) are directed to the establishment of a connection between a buyer 11 and a seller, preferably, a plurality of sellers 12a-12n, of real estate property 13, for brokering a sale thereof. Each of the participants 11,12a-12n has access to a processor 14,15a-15n having access to a network such as the Internet 16 and thereby access to electronic mail.

A host site 17 comprises a processor 18 having access to the Internet 16 and in signal communication with a database 19. The host site processor 18 has resident thereon a software package 20 comprising code segments adapted to maintain a website 21 for assisting in brokering a sale of the property 13, which can include the method steps 100 outlined in FIGS. 2A-2C.

Once the website 21 has been established (block 101), a community of sellers are solicited to purchase a subscription to the service offered by the website (block 102). Such solicitation can take the form of any type of advertisement known in the art. From among those solicited, which can include builders, individual property owners, or banks or other mortgage holders, for example, and from among others who come to the website by other means, the plurality of sellers 12a-12n who ultimately purchase a subscription are prompted to enter data on the property 13 (block 103) or other commodity. The entered commodity data can include, but are not intended to be limited to, location, asking price, photograph(s) of the property, number and type of rooms, age of property, foreclosure or pre-foreclosure status, schools serving the location, upgraded features (drapery, carpeting, kitchen elements, etc.), date available, handicap accessibility, propinquity of a golf course, body of water, or shopping, size of building and land, swimming pool, garage/parking data, the presence of a neighborhood/condominium association, assumption of closing costs, etc. The commodity data are stored in a sector 22 of the database 19 housing seller data (block 104).

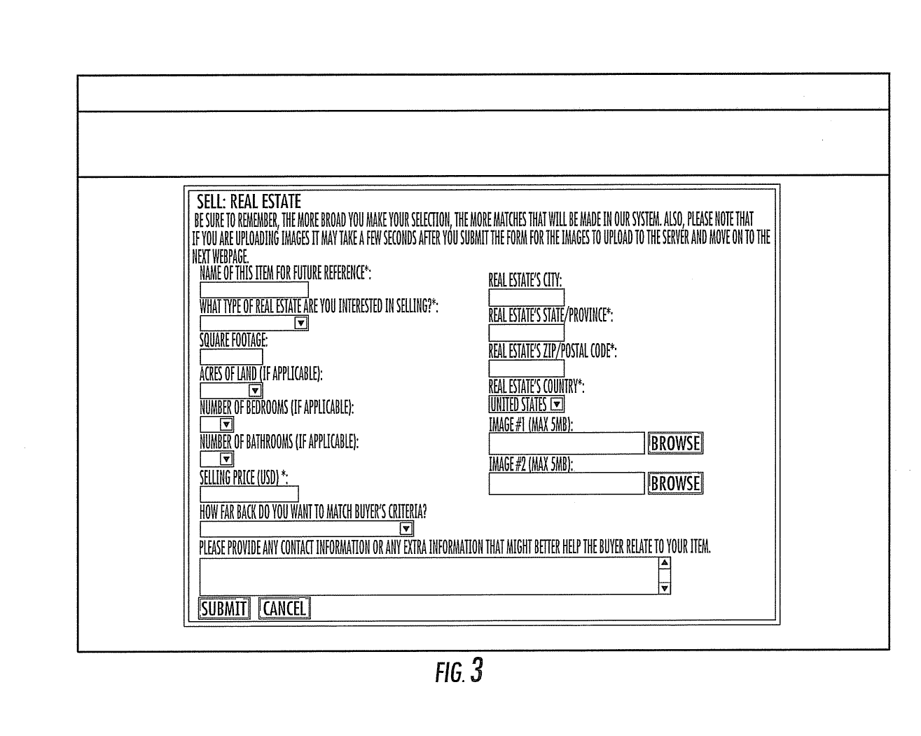

Referring to FIG. 3, an exemplary web page for entering commodity data includes a plurality of fields appropriate to the commodity type into which the commodity data may be entered. While the displayed fields are appropriate for real estate, it will be appreciated that varying fields can be used to capture more useful data for other commodity types. The web page also allows the uploading of image files and permits the seller to identify a date range matching previously entered purchase criteria (for instance, in the case of sellers entering commodity data that may match previously entered purchase criteria, as described below).

The seller 12a-12n may elect in some circumstances to purchase an “enhanced” membership (block 105), which entails features to be discussed in the following.

Once the database 19 has sufficient data to open the website 21 to buyers, a potential buyer 11 can enter the website 21 (block 106).

The buyer 11 is requested to provide demographic data and a set of purchase criteria (block 107), which are received and entered into a sector 23 the database 19 housing buyer data (block 108). The purchase criteria can include, but are not intended to be limited to, price range, search location, pre-approval data, income, employer, schools, and physical characteristics of the property, such as number and type of rooms, handicap accessibility, propinquity of a golf course, body of water, or shopping, acceptable age range of property, size of building and land, kitchen and bath features, swimming pool, garage/parking data, the presence of a neighborhood/condominium association, date needed by, etc. Other data entered by the buyer 11 can include which of the entered data the buyer 11 does not wish transmitted to a seller 12a-12n (block 109).

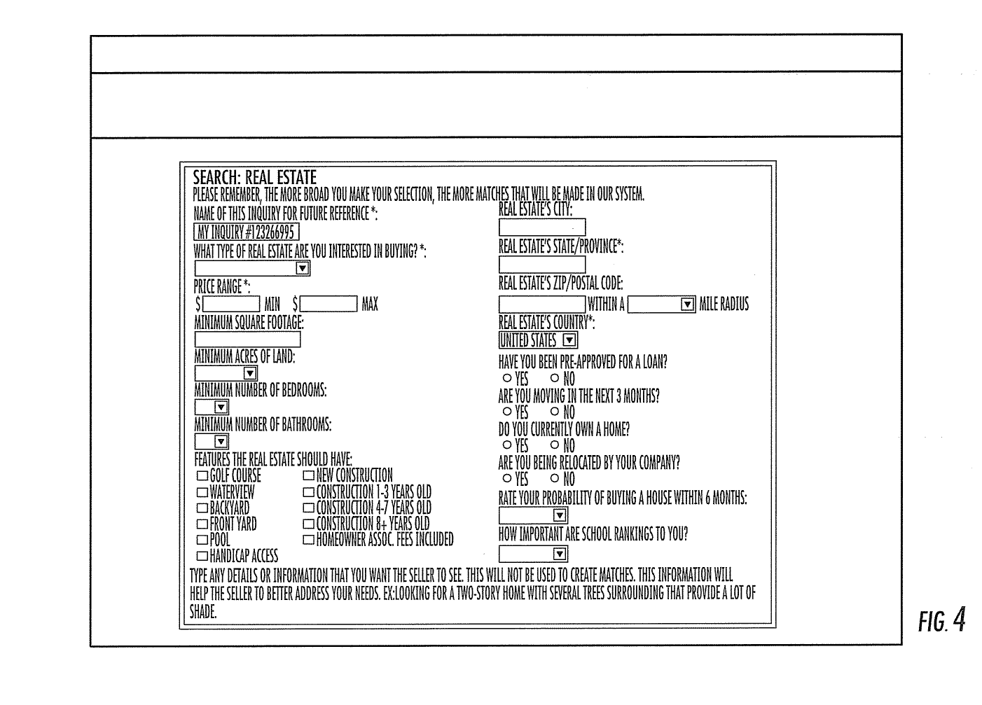

Referring to FIG. 4, an exemplary webpage for entering purchase criteria includes a plurality of fields for entering purchase criteria appropriate to the commodity type. While the displayed fields are appropriate for real estate, it will be appreciated that varying fields can be used to capture more useful data for other commodity types.

In a particular embodiment, the buyer 11 is not charged a fee for the service, unless the buyer 11 elects to purchase an “enhanced” membership, which will be discussed in the following (block 110).

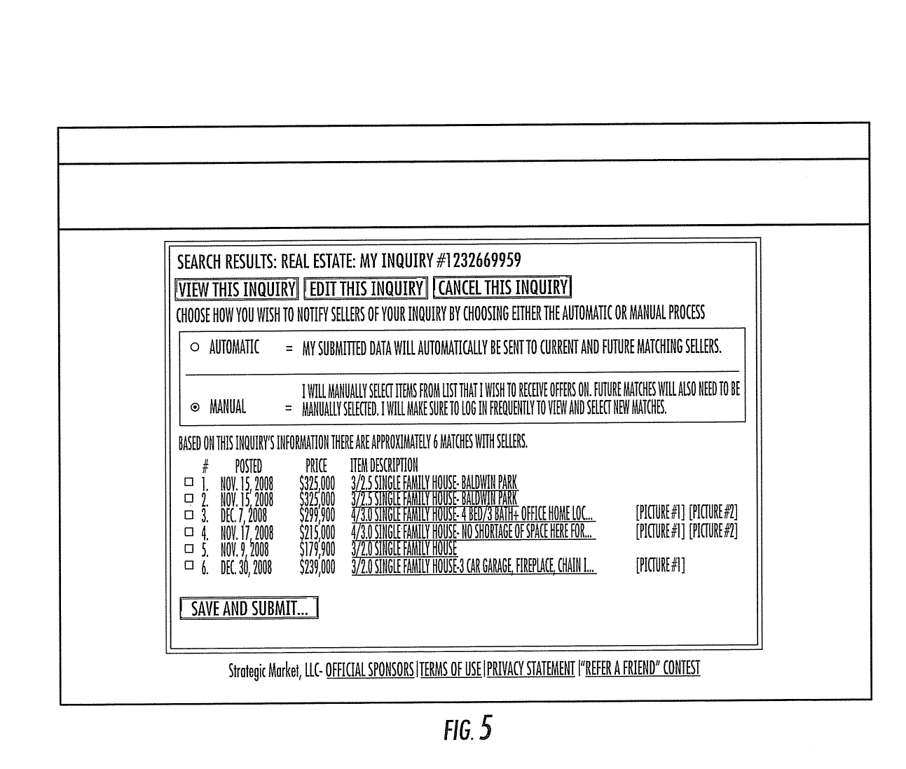

The software package 20 accesses the buyer's criteria set from the database's buyer sector 23 and queries the database's seller sector 22 (block 111). The query method includes using the buyer's criteria set as a filter, and creating a data set comprising at least one potential seller having a commodity matching at least some of the buyer's criteria set (block 112). Referring to FIG. 5, an exemplary web page displaying the data set to the buyer includes a list of the matching commodities, which the buyer can select to see more details. The buyer can opt to automatically transmit the buyer's criteria to sellers of all current and future matching properties, or manually select properties to whom the criteria is to be transmitted.

The software 20 then transmits to at least one of the sellers 12a in the data set the subset of the buyer's demographic data approved for transmittal and criteria set (block 113). The seller 12a can then, if desired, contact the buyer 11 directly and make an offer of the property 13 (block 114). In some cases, negotiations can be entered into (block 115), perhaps with multiple sellers 12a-12n, in order to reach an optimal result for the buyer 11. Alternatively, the negotiations in some markets or for some properties may include multiple buyers making offers to one seller. The seller(s) 12a-12n may be motivated, as part of the negotiation, to lower the asking price, provide incentives such as upgraded features, money towards closing, etc. If successful (block 116), a purchase can be completed between the buyer 11 and one of the sellers 12a-12n (block 117). If not successful (block 116), the process can begin again with altered criteria, can begin again at a later date, or can halt.

As mentioned above, a buyer 11 can elect to purchase an “enhanced” membership (FIG. 1B; block 110). This option enters the buyer 11 into a “rating” system that collects additional data from the buyer 11 (block 117), such as, but not intended to be limited to, pre-qualification data, annual income, likelihood of moving or buying, timeline of move, and the existence of current home to be sold. These data are also stored in the buyer's database sector 23 (block 118).

The software 20 calculates from the buyer's entered data a “ranking” of that buyer 11, wherein a value is calculated that represents the likelihood of a successful purchase (block 119). This feature can provide the seller 12a-12n an ability to make a better offer to a highly qualified buyer 11, since the purchase likelihood is high.

Also as mentioned above, the seller 12a-12n can elect to purchase an “enhanced” subscription (FIG. 1C; block 105). In this option, the seller 12a-12n has access to the results of the rating system, that is the “ranking” of the potential buyer 11 (block 120). This ranking can be a good indicator of the buyer's qualifications and intentions (block 121).

The system 10 and method 100 of the present invention have a plurality of benefits and features. For example, home builders can have the opportunity to contact a qualified buyer directly without the intervention of a realtor. Individual sellers without realtors can be contacted by potential buyers and assess their (filtered) data set before making an offer. Buyers can enter one website 21, enter their data once, and have immediate access to a plurality of sellers 12a-12n, who may elect to offer incentives not available any other way, or that are not advertised to the public at large. Buyers have no need to contract with a realtor, thereby eliminating one source of additional cost. Sellers in a pre-foreclosure status can offer their property at much-reduced prices and possibly avoid foreclosure. Institutional sellers who are mortgage holders can offer foreclosed properties to a wide array of buyers without necessarily having to initiate an auction, at which prices are often well below market value.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and method illustrated and described herein are by way of example, and the scope of the invention is not limited to the exact details of construction and use.

What is claimed is:

1. A commodity brokering system comprising:
a host site including:
a processor connected to the Internet and adapted to maintain a website; and
a database in signal communication with the processor;
wherein the processor is configured to:
receive commodity data from a plurality of sellers through the website, the commodity data relating to a plurality of commodities offered for sale by the plurality of sellers;
store the commodity data in the database;
receive purchase criteria from at least one buyer through the website;
store the purchase criteria in the database;
display all of the plurality of commodities to the at least one buyer which correspond to the purchase criteria; and
communicate the purchase criteria to at least one seller offering for sale at least one of the plurality of commodities corresponding to the purchase criteria.

2. The system of claim 1, wherein the processor is further configured to:
receive a sale offer from the at least one seller to whom the purchase criteria was communicated; and
communicate the sale offer to the at least one buyer.

3. The system of claim 1, wherein the processor is further configured to:
receive a selection from the at least one buyer from among the plurality of displayed commodities; and
only communicate the purchase criteria to sellers associated with the selected commodities.

4. The system of claim 1, wherein the processor is further configured to:
collect ranking information from the at least one buyer; and
display ranking information for the at least one buyer to the at least one seller to whom the purchase criteria was communicated.

5. The system of claim 4, wherein the processor is further configured to solicit payment from the at least one seller to whom the purchase criteria was communicated to display the ranking information.

6. The system of claim 4, wherein the processor is further configured to solicit payment from the at least one buyer to collect the ranking information.

7. The system of claim 4, wherein the ranking information includes at least one of ability to pay data and likelihood of purchase data.

8. The system of claim 1, wherein the plurality of commodities include real estate and automobiles.

9. A commodity brokering method comprising:
hosting a website accessible through the Internet by a plurality of sellers and buyers of commodities;
receiving commodity data from the plurality of sellers;
storing the plurality of commodity data in a database;
receiving purchase criteria from the plurality of buyers;
storing the purchase criteria in the database;
matching each buyer with at least one of the plurality of sellers by comparing the commodity data and the purchase criteria;
communicating the purchase criteria to the at least one matching seller.

10. The method of claim 9, further comprising receiving sale offers from the plurality of sellers and communicating the sale offers to the matching buyers.

11. The method of claim 9, wherein the commodity data and purchase criteria include commodity type and commodity price.

12. The method of claim 9, further comprising displaying commodity data to the buyer associated with the at least one matched seller.

13. The method of claim 12, further comprising receiving a selection from the buyer of at least one commodity associated with the displayed commodity data and communicating the purchase criteria only the seller associated with the selected commodity.

14. The method of claim 9, further comprising receiving ranking information from the at least one buyer and communicating the ranking information to the at least one matched seller.

15. The method of claim 14, wherein the at least one seller must pay to receive the ranking information.

16. The method of claim 14, wherein the at least one buyer must pay to enter the ranking information.

17. The method of claim 15, wherein the ranking information includes at least one of ability to pay data and likelihood of purchase data.

18. The method of claim 9, wherein the commodity data is associated with a plurality of commodity types including real estate and automobiles.
